(19) United States
(12) Patent Application Publication
(10) Pub. No.: US 2015/0107348 A1
(43) Pub. Date: Apr. 23, 2015

(54) METHOD AND APPARATUS FOR INSPECTING A FLUIDIC DEVICE

(71) Applicant: CANON KABUSHIKI KAISHA, Tokyo (JP)

(72) Inventor: Eishi Igata, Port Washington, NY (US)

(21) Appl. No.: 14/506,789

(22) Filed: Oct. 6, 2014

(30) Foreign Application Priority Data
Oct. 17, 2013 (JP) 2013-216059

(51) Int. Cl. G01N 19/04; G01F 1/00

(52) U.S. Cl. CPC G01N 19/04; G01F 1/00
USPC 73/150 A

(57) ABSTRACT

A curing degree of a bonding layer is checked when a hollow microchannel is produced by bonding a plurality of plates through intermediation of the bonding layer. Provided is a method of inspecting a fluidic device including: one substrate and another substrate, at least one of the substrates having a minute groove formed therein; and a hollow channel formed by bonding the substrates to each other through intermediation of an adhesive layer having a contact angle that changes depending on a curing degree by irradiation of light. The method includes measuring a flow rate at which a solution flows through the channel with a capillary force when no liquid is present after the irradiation of light.

### BACKGROUND OF THE INVENTION

1. Field of the Invention

The present invention relates to a method and apparatus for inspecting a fluidic device.

2. Description of the Related Art

In the field of analytical chemistry, it is a fundamental matter to acquire desired information such as a concentration and a component, in order to verify a process or results of a chemical reaction or a biochemical reaction, and hence various devices and sensors have been invented to acquire such pieces of information. A concept referred to as “micro total analysis systems (μ-TAS)” or “lab on a chip” has been known, which reduces sizes of such devices and sensors to a microscale level to achieve all processes up to acquisition of the desired information on a microdevice. This is a concept aiming at undergoing a process such as specimen purification or a chemical reaction by causing a collected raw material or a crude specimen to pass through a channel in the microdevice and finally acquiring the concentration of a component or the like included in a chemically synthesized product or the specimen. The microdevice that is responsible for the analysis and the reaction inevitably handles a trace of solution or gas, and hence such a microdevice is often referred to as “microchannel device” or “microfluidic device”.

Comparing to a desktop-sized analysis device of the related art, the use of the microchannel device leads to reduction in volume of the fluid in the device, and hence reduction in required amount of a reagent and reduction in reaction time due to reduction in amount of an analyte to a microscale level are expected. With an acknowledgement of the advantage of the microchannel device, technologies involved in the μ-TAS have been attracting attention.

When a microchannel is produced by bonding a plurality of substrates to each other through use of a bonding layer such as an adhesive, it is necessary that the bonding layer bonds the substrates to each other securely. In order to achieve secure bonding, it is desired that the bonding layer be cured completely, and typically, there is given an example in which the substrates are bonded through use of a UV-curable adhesive as disclosed in Japanese Patent No. 3880931.

The channel sectional area of the microchannel thus produced is generally minute. Therefore, in order to inspect the inside of the microchannel, it is necessary that sensors, which may fit the minute channel sectional area, be disposed in the microchannel and the flow of a fluid be not inhibited by the sensors. The inspection of the inside of the produced microchannel depends on visual examination in most cases, and the inspection in a functional aspect is difficult to be performed.

The microchannel disclosed in Japanese Patent No. 3880931 is formed by bringing a substrate having a groove on a surface thereof and a substrate not having a groove into contact with each other so as to form a hollow channel, causing an adhesive to pass through a gap between the two substrates with a capillary force, and irradiating the adhesive with UV-light to cure the adhesive. In this case, the adhesive film becomes thin.

Compared to a thick film, the specific interfacial area of the thin adhesive film increases, and hence the area thereof that is subject to oxygen inhibition when the adhesive is cured also increases. The adhesive for forming the microchannel is partially exposed to air in the channel, and hence there is a risk in that the adhesive may not be cured with a UV-light irradiation amount equal to that for producing a thick film in a portion exposed to the channel. When the adhesive is not cured completely, the substrates remain adhering to each other because of the adhesiveness of the adhesive. However, the fluidity is lost, with the result that liquid cannot smoothly pass through the microchannel. Further, when the adhesive is not cured, a part of the adhesive may peel off due to the flow and become a factor of inhibiting the reaction in the microchannel. However, whether the adhesive is not cured or is completely cured cannot be determined merely with visual examination.

### SUMMARY OF THE INVENTION

The present invention provides a method of inspecting whether or not an adhesive is completely cured, which cannot be determined with visual examination, with respect to a microchannel formed by bonding substrates with an adhesive layer.

According to one embodiment of the present invention, there is provided a method of inspecting a fluidic device including: one substrate and another substrate, at least one of the substrates having a groove formed therein; and a hollow channel formed by bonding the substrates to each other through intermediation of an adhesive layer having a contact angle that changes depending on a curing degree, the method including measuring a flow rate at which a solution flows through the hollow channel with a capillary force.

According to one embodiment of the present invention, there is provided an apparatus for inspecting a fluidic device including: one substrate and another substrate, at least one of the substrates having a minute groove formed therein; and a hollow channel formed by bonding the substrates to each other through intermediation of an adhesive layer having a contact angle that changes depending on a curing degree, the apparatus including: an imaging device configured to acquire a flow of a solution caused by a capillary force in the hollow channel when no liquid is present after being irradiated with light; and a calculator configured to calculate a flow rate at which the solution flows based on data of the imaging device.

According to one embodiment of the present invention, the curing degree of a bonding layer in the microchannel formed by bonding the plurality of substrates through intermediation of the bonding layer can be inspected easily.

Further features of the present invention will become apparent from the following description of exemplary embodiments with reference to the attached drawings.

### BRIEF DESCRIPTION OF THE DRAWINGS

FIG. 1 is a graph showing a correlation between a change in contact angle and a flow rate in the present invention.

FIG. 2 illustrates one mode for performing an inspection method of the present invention.

FIG. 3 is a channel sectional view for performing the inspection method of the present invention.

FIG. 4 is a graph showing an experimental result obtained by performing the inspection method of the present invention.

FIG. 5 is a channel sectional view for performing the inspection method of the present invention.

### DESCRIPTION OF THE EMBODIMENTS

The present invention is hereinafter described in detail.

According to one embodiment of the present invention, there is provided a method of inspecting a fluidic device including: one substrate and another substrate, at least one of the substrates having a groove formed therein; and a hollow channel formed by bonding the substrates to each other through intermediation of an adhesive layer having a contact angle that changes depending on a curing degree, the method including measuring a flow rate at which a solution flows through the hollow channel with a capillary force.

According to one embodiment of the present invention, there is provided an apparatus for inspecting a fluidic device including: one substrate and another substrate, at least one of the substrates having a minute groove formed therein, and a hollow channel formed by bonding the substrates to each other through intermediation of an adhesive layer having a contact angle that changes depending on a curing degree, the apparatus including: an imaging device configured to acquire a flow of a solution caused by a capillary force in the hollow channel when no liquid is present after being irradiated with light; and a calculator configured to calculate a flow rate at which the solution flows based on data of the imaging device.

Examples of the material for the substrate include glass, plastic, silicon, and ceramics. The width of the groove may be about 1 μm or more and about 1 mm or less so that the influence by the capillary force can be observed easily, and a production method of the groove significantly depends on the material. For example, microprocessing using photolithography is used when the material is silicon; injection molding or hot embossing is used when the material is plastic; and drilling is used when the material is glass. However, the production method is not particularly limited thereto.

The adhesive layer is typically an adhesive, and examples thereof include a UV-curable adhesive, a heat-curable adhesive, and a two-solution mixed adhesive. Further, considering the compatibility with the substrate, an adhesive that can be uniformly applied to the substrate to a thickness of about several micrometers is desired. For example, when the substrate is made of hydrophilic glass, it is desired that the adhesive also have hydrophilicity. Of the adhesives, in particular, the UV-curable adhesive has an advantage in a high curing rate. Note that, it is necessary to irradiate the adhesive with UV-light through the substrate, and hence the UV-light absorption rate of the substrate needs to be small and the thickness of the substrate is limited.

The curing degree of the adhesive depends on the irradiation amount and irradiation density of light, the content of a curing initiator, and the like. When a certain UV-curable adhesive is applied to the surface of the substrate and the substrates are not bonded to each other yet, the curing degree can be estimated from the measurement of a contact angle of the adhesive with respect to water, for example, when the UV-light irradiation amount is changed at a predetermined UV-light irradiation density or from the measurement of FTIR. When the contact angle of the adhesive with respect to a solution to be used for the inspection is measured simultaneously, the correlation between the curing degree and the contact angle is obtained.

In order to bond the substrates without closing a microchannel having a depth of from tens of micrometers to hundreds of micrometers with an adhesive, it is desired that the thickness of the adhesive layer be several micrometers. In order to realize this thickness, there are given a method of dissolving an adhesive in a solvent to perform spin coating, a method of performing spray coating, a method of performing dip coating, and a method of performing printing. However, the method is not particularly limited thereto.

It is sufficient that the solution for measuring a flow rate be a fluid having known surface tension and contact angle depending on the curing degree. Note that, a solvent that dissolves the substrate and the adhesive layer, and a solution that may inhibit the reaction to be conducted in a microchannel are not preferred.

A penetration distance L of a solution by a capillary force in a channel having a radius r can be estimated by the following Lucas-Washburn equation:

L={rT cos θ·t/2μ}^{1/2}

where T represents surface tension of a fluid; θ represents a contact angle of the solution with respect to the channel; t represents time; and μ represents the viscosity of the solution. When the above-mentioned equation is solved for the time t, the following equation is obtained.

t=2μL²/(rT cos θ)

Thus, the value of the time required for the solution to pass between two particular points depends on the contact angle θ.

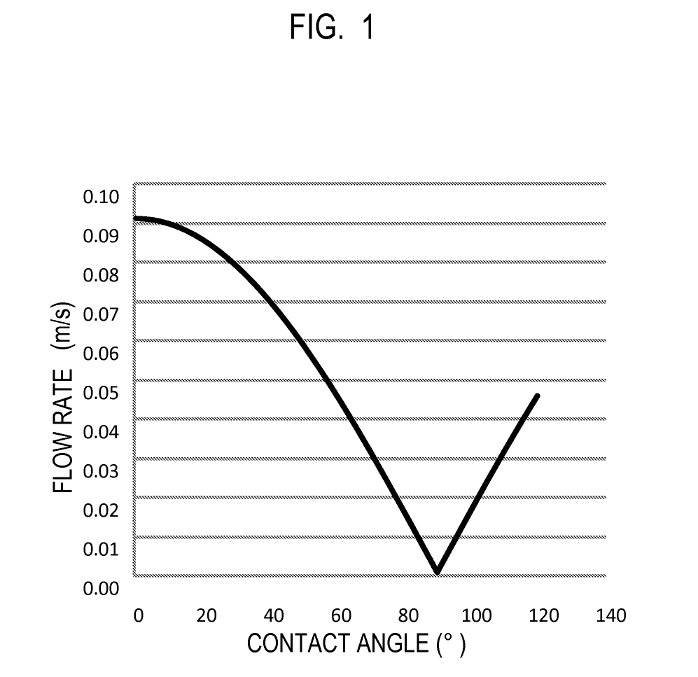

FIG. 1 is a graph showing the dependency of the flow rate on the contact angle of a fluid in the case where a solution having a viscosity of 1 mPa·s and a surface tension of 73 mN/m is proceeding only with a capillary force in a microchannel having a channel radius of 50 μm and a channel length of 20 mm. The channel passage time is inversely proportional to a cosine component of the contact angle, and hence abruptly increases in the vicinity of the contact angle of 90°. Therefore, the flow rate becomes theoretically 0. That is, the adhesive having a contact angle in the vicinity of 90° (for example, from 80° to 90°) before being cured and having a contact angle of 70° or less after being completely cured causes a difference in passage speed of the solution. The same also applies to the adhesive having a contact angle of 70° or less before being cured and having a contact angle in the vicinity of 90° (for example, from 80° to 90°) after being cured completely. Specifically, when the contact angle θ is 70°, the time t is 0.64 seconds, and hence the flow rate is calculated to be 0.031 m/s. Further, when the contact angle θ is 85° in the same channel, the time t is 2.49 seconds, and hence the flow rate is calculated to be 0.008 m/s. With such a time difference and speed difference, calculation can be performed easily without using a special device.

The present invention inspects, based on the above-mentioned principle, a fluidic device by measuring a flow rate of a fluid proceeding with a capillary force in a microchannel produced through use of an adhesive layer whose contact angle changes depending on the curing degree, thereby estimating the curing degree of the adhesive layer.

According to the inspection method of the present invention, the state in the channel of one embodiment of a microfluidic device can be inspected in a nondestructive manner. In the case where the complete curing of an adhesive film cannot be confirmed by the inspection, the solution for inspection can be removed from the channel, and the adhesive film can be irradiated with UV-light again to be cured completely. Thus, there is an effect that it is not necessary to remove a device only for the inspection during the production process of the device.

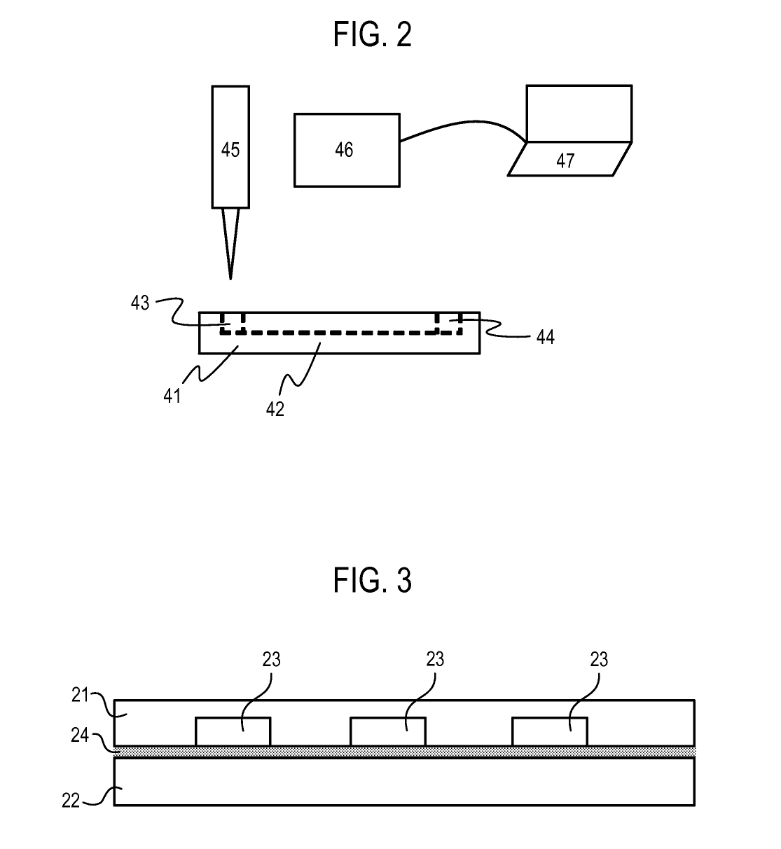

Owing to the above-mentioned effect, the present invention can incorporate the determination of the complete curing of the adhesive film into a production line. For example, in a system as illustrated in FIG. 2, a fluidic device 41 includes a hollow channel 42, and an injection port 43 and a discharge port 44 for a solution. A solution to be used for measuring a flow rate is dropped with a pipette 45, and the state in which the solution proceeds with a capillary force is imaged with an imaging device 46. The image data thus acquired is sent to a calculator 47, and image analysis is performed based on two images at any different times. Thus, the flow rate of the solution can be calculated. In this case, in order to facilitate the analysis of the images, the fluidic device 41 may be irradiated with light having a particular non-UV wavelength or white light for observation, and the solution for inspection may be colored or may emit fluorescent light. Further, when filters necessary for imaging are required, a filter according to a fluorescent wavelength or the like may be appropriately used.

### EXAMPLES

Now, the present invention is described further specifically by way of examples. Note that, the following examples are shown merely for describing the present invention in more detail, and the present invention is not limited to the following examples.

### Example 1

In Example 1, an adhesive curing inspection method for a microchannel produced through use of a UV-curable adhesive having a contact angle of about 80° with respect to water before being cured is described.

FIG. 3 is a sectional view of a microchannel device in this example. A plurality of grooves having different lengths, each having a width of 100 μm and a depth of 50 μm, are formed by drilling on a surface of a substrate 21 made of an acrylic material, and a hole having a radius of about 1 mm for injecting liquid is formed at each end of the groove. A UV-curable adhesive 24 such as World Rock 5541 (trademark) (viscosity: 2,000 mPa·s, manufactured by Kyoritsu Chemical & Co., Ltd.) was applied to another substrate 22 having an unprocessed surface to a thickness of about 3 μm, and the substrate 22 was bonded to the substrate 21 having the grooves and holes to form microchannels 23. In this case, the microchannel 23 thus formed was not filled with the adhesive, and no voids communicating to the microchannel 23 were formed.

The adhesive 24 applied to the substrate 22 was irradiated with UV-light at an irradiation density of 50 mW/cm² in irradiation amounts of 3 J/cm² and 24 J/cm² to be cured, and the contact angle of the adhesive 24 with respect to water was measured to be 80° and 68°, respectively. When the irradiation amount was 3 J/cm², the adhesive film had tackiness, and the adhesive film lacked fluidity, but still kept adhesiveness. When the irradiation amount was 24 J/cm², the adhesive film lost adhesiveness and was cured completely.

Next, the substrates 21 and 22 were bonded through intermediation of the adhesive 24. The adhesive 24 was cured with UV-light at an irradiation density of 50 mW/cm² in irradiation amounts of 3 J/cm² and 24 J/cm² to form two fluidic devices. At this time, the microchannels of both the devices were inspected with a microscope. No difference was found therebetween by visual examination. Note that, only one of four wall surfaces surrounding four sides of the microchannel 23 in a cross section perpendicular to the longitudinal direction of the microchannel 23 was held in contact with the adhesive 24.

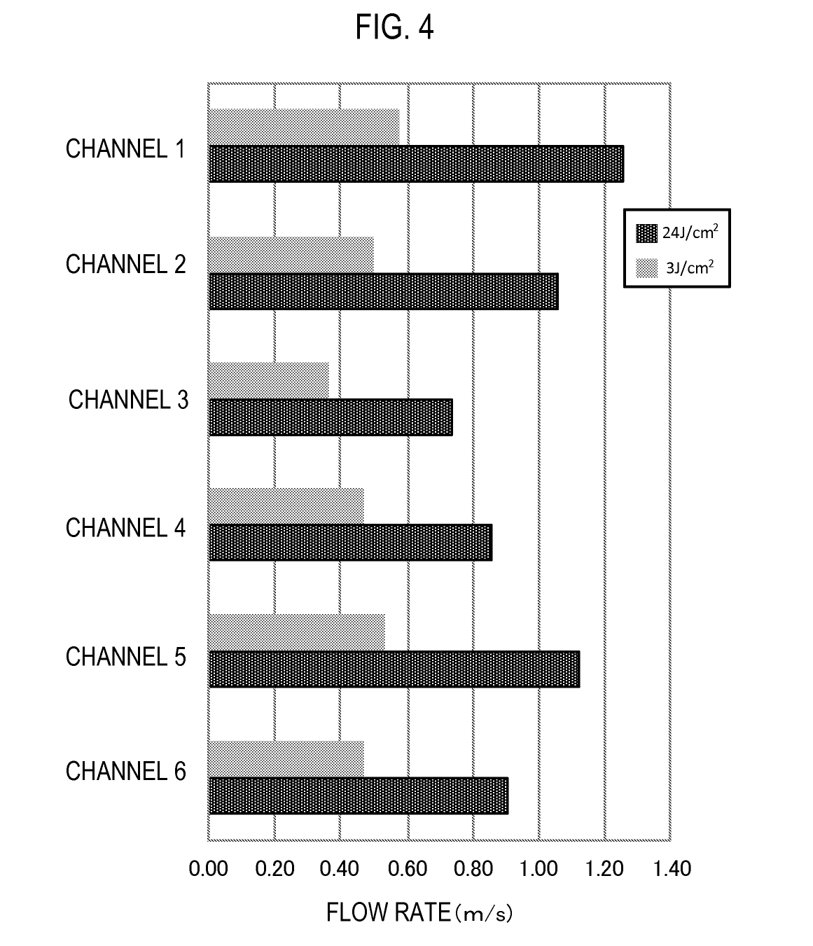

About 10 μL of water were dropped onto the hole in the substrate 21 to measure the time for the water to proceed in each microchannel 23. FIG. 4 is a graph showing flow rates measured respectively when each microchannel 23 was irradiated with UV-light in irradiation amounts of 3 J/cm² and 24 J/cm². In each microchannel 23, the flow rate in the irradiation amount of 24 J/cm², in which the complete curing of the adhesive 24 was confirmed, increased. Note that, only in one of four sides of the microchannel 23 in this example, the adhesive layer is brought into contact with the solution as illustrated in FIG. 3. Therefore, a change in flow rate caused by a change in contact angle was not the one obtained from the Lucas-Washburn equation. Nonetheless, it is clear that whether or not the adhesive 24 has been cured is known by checking the flow rate.

### Example 2

In Example 2, a UV-curable adhesive is described in which the contact angle of an uncured adhesive film with respect to water is adjusted to about 60°.

The contact angle of the adhesive is significantly influenced by the content of the adhesive. For example, when a surfactant capable of being blended with a solvent contained in the adhesive is added, the contact angle of the adhesive before being cured decreases. In the case of using a hydrophilic substrate such as a glass substrate, an adhesive having a lower contact angle is desired for uniform application of the adhesive.

Further, when the contact angle of the adhesive after being cured is set to increase to the vicinity of 90°, a difference can be caused in a flow rate by a capillary force in a microchannel to such a degree as to be easily observed before and after curing of the adhesive.

As is apparent also from FIG. 1, when the contact angle increases from about 80° to about 90°, the flow rate abruptly decreases. Therefore, the curing degree can be more easily estimated.

### Example 3

As Example 3, a case where curing is determined easily by excess irradiation to an adhesive is described.

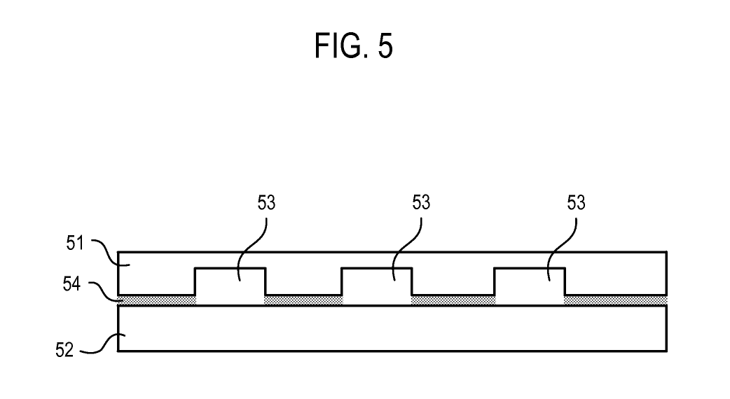

A microchannel 53 obtained by bonding substrates and 52 to each other through intermediation of an adhesive 54 as illustrated in FIG. 5 is considered. The adhesive 54 is exposed to only a part of the microchannel 53, and hence a change in flow rate caused by a change in contact angle ascribed to the adhesive curing is smaller than that in the state of FIG. 3. The change in flow rate thereof is small, and hence there is risk in that the flow rate may not be measured by a simple method.

In such a case, the contact angle can be further changed by irradiating the adhesive film with excess UV-light in a UV-light irradiation amount larger than necessary to such a degree that the substrate and the adhesive film are not damaged with the UV-light. In the case of the adhesive used in Example 1, the contact angle of the adhesive surface with respect to water decreased to about 43° due to the UV-light irradiation of 45 J/cm².

In order to cause the method of this example to function effectively, it is necessary to consider the combination of a channel material and the adhesive. For example, when the substrate 51 is made of cyclic polyolefin or polypropylene having a contact angle of about 90° with respect to water, the contact angle between the adhesive and the water is about 90° in an uncured state. When the contact angle is decreased to about 40° by further excess irradiation after curing, a flow rate difference can be easily measured.

Further, when the substrate 51 is made of a hydrophilic material such as glass, the contact angle between the adhesive and the water is about 30° in an uncured state. When the contact angle is increased to about 90° by further excess irradiation after curing, a flow rate difference can be measured easily.

The present invention can be used for a microfluidic device for performing a chemical reaction and chemical analysis.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-216059, filed on Oct. 17, 2013, which is hereby incorporated by reference herein in its entirety.

What is claimed is:

1. A method of inspecting a fluidic device including: one substrate and another substrate, at least one of the substrates having a groove formed therein; and a hollow channel formed by bonding the substrates to each other through intermediation of an adhesive layer having a contact angle that changes depending on a curing degree,
the method comprising measuring a flow rate at which a solution flows through the hollow channel with a capillary force.

2. A method of inspecting a fluidic device according to claim 1, further comprising inspecting the curing degree of the adhesive layer based on the flow rate at which the solution flows.

3. A method of inspecting a fluidic device according to claim 1, wherein the contact angle between the adhesive layer before being cured and the solution is in a range of from 80° to 90°, and the contact angle between the adhesive layer after being cured and the solution is 70° or less.

4. A method of inspecting a fluidic device according to claim 1, wherein the contact angle between the adhesive layer before being irradiated with light and the solution is 70° or less, and the contact angle between the adhesive layer after being irradiated with light and the solution is in a range of from 80° to 90°.

5. A method of inspecting a fluidic device according to claim 1, wherein the adhesive layer is cured by irradiation of light.

6. A method of inspecting a fluidic device according to claim 1, wherein the hollow channel has a width of 1 μm or more and 1 mm or less.

7. An apparatus for inspecting a fluidic device including: one substrate and another substrate, at least one of the substrates having a minute groove formed therein; and a hollow channel formed by bonding the substrates to each other through intermediation of an adhesive layer having a contact angle that changes depending on a curing degree,
the apparatus comprising:
an imaging device configured to acquire a flow of a solution caused by a capillary force in the hollow channel when no liquid is present after being irradiated with light; and
a calculator configured to calculate a flow rate at which the solution flows based on data of the imaging device.

8. An apparatus for inspecting a fluidic device according to claim 7, wherein the curing degree of the adhesive layer is inspected based on the flow rate at which the solution flows.

9. An apparatus for inspecting a fluidic device according to claim 7, wherein the contact angle between the adhesive layer before being cured and the solution is in a range of from 80° to 90°, and the contact angle between the adhesive layer after being cured and the solution is 70° or less.

10. An apparatus for inspecting a fluidic device according to claim 7, wherein the contact angle between the adhesive layer before being irradiated with light and the solution is 70° or less, and the contact angle between the adhesive layer after being irradiated with light and the solution is in a range of from 80° to 90°.

11. An apparatus for inspecting a fluidic device according to claim 7, wherein the adhesive layer is cured by irradiation of light.

12. An apparatus for inspecting a fluidic device according to claim 7, wherein the hollow channel has a width of 1 μm or more and 1 mm or less.
